(19) United States
(12) Patent Application Publication
(10) Pub. No.: US 2012/0127609 A1
(43) Pub. Date: May 24, 2012

(54) SYSTEM, METHOD AND APPARATUS FOR PERPENDICULAR MAGNETIC RECORDING MEDIA HAVING DECOUPLED CONTROL AND GRADED ANISOTROPY

(75) Inventors: Jack J. Chang, Fremont, CA (US); Zhupei Shi, San Jose, CA (US)

(73) Assignee: Hitachi Global Storage Technologies Netherlands B.V., Amsterdam (NL)

(21) Appl. No.: 12/948,813

(22) Filed: Nov. 18, 2010

(51) Int. Cl. G11B 5/127; G11B 5/667

(52) U.S. Cl. 360/110; 428/828.1; G9B/5.04

(57) ABSTRACT

A structure for high performance perpendicular magnetic recording media has a substrate with a plurality of sequential layers including an adhesion layer, a first soft underlayer (SUL), a coupling layer, a second SUL, a seed layer, a Ru layer, and an onset layer; at least one oxide layer on the onset layer and having a composition with graded anisotropy to improve overwrite of the media; an exchange coupling layer (ECL) on the at least one oxide layer; a cap layer; a decoupling-controlled layer between the ECL and the cap layer to reduce lateral exchange coupling in the cap layer on the ECL; and a carbon overcoat on the cap layer.

### BACKGROUND OF THE INVENTION

1. Field of the Disclosure

The present invention relates in general to hard disk drives and, in particular, to a system, method and apparatus for perpendicular magnetic recording (PMR) media having a decoupling-controlled layer and graded anisotropy.

2. Description of the Related Art

FIG. 1 depicts a conventional PMR media 21 comprising a substrate 23, an adhesion layer 25, and a pair of soft underlayers (SUL) 27, 29 coupled by a coupling layer 31. Sequentially layered on SUL 29 are a seed layer 33, a Ru layer 35, an onset layer 37, homogenous oxide layers 39, an exchange coupled layer (ECL) 41, a cap layer 43 and a carbon overcoat (COC).

Performance parameters for PMR media 21, such as signal-to-noise ratio (SNR), overwrite (OW), and magnetic core width (MCW), pose difficult trade-offs when trying to achieve higher areal density. Higher performing PMR media, however, require continuous improvement in all of these parameters. A new structure and design that simultaneously improve SNR and OW at a given MCW are disclosed.

### SUMMARY

Embodiments of a system, method and apparatus for perpendicular magnetic recording (PMR) media having a decoupling-controlled layer and graded anisotropy are disclosed. In some embodiments, the PMR media comprises a substrate having a plurality of sequential layers comprising an adhesion layer, a first soft underlayer (SUL), a coupling layer, a second SUL, a seed layer, a Ru layer, and an onset layer. At least one oxide layer is on the onset layer and has a composition with graded anisotropy to improve overwrite of the PMR media. An exchange coupling layer (ECL) is on the oxide layer, followed by a cap layer. A decoupling-controlled layer is located between the ECL and the cap layer to reduce lateral exchange coupling in the cap layer on the ECL.

The foregoing and other objects and advantages of these embodiments will be apparent to those of ordinary skill in the art in view of the following detailed description, taken in conjunction with the appended claims and the accompanying drawings.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIG. 1 is a schematic sectional view of a conventional PMR structure;

FIG. 2 is a schematic sectional view of an embodiment of a PMR structure;

FIGS. 3-9 are plots of coercivity, nucleation field, switching field distribution, saturation field, overwrite, magnetic core width and signal-to-noise ratio, respectively, comparing the performance of conventional media to various embodiments of media structure;

FIGS. 10 and 11 are plots comparing soft error rate and overwrite, respectively, as functions of magnetic core widths of conventional structures and embodiments of media structure; and

FIG. 12 is a schematic diagram of an embodiment of a disk drive.

The use of the same reference symbols in different drawings indicates similar or identical items.

### DETAILED DESCRIPTION

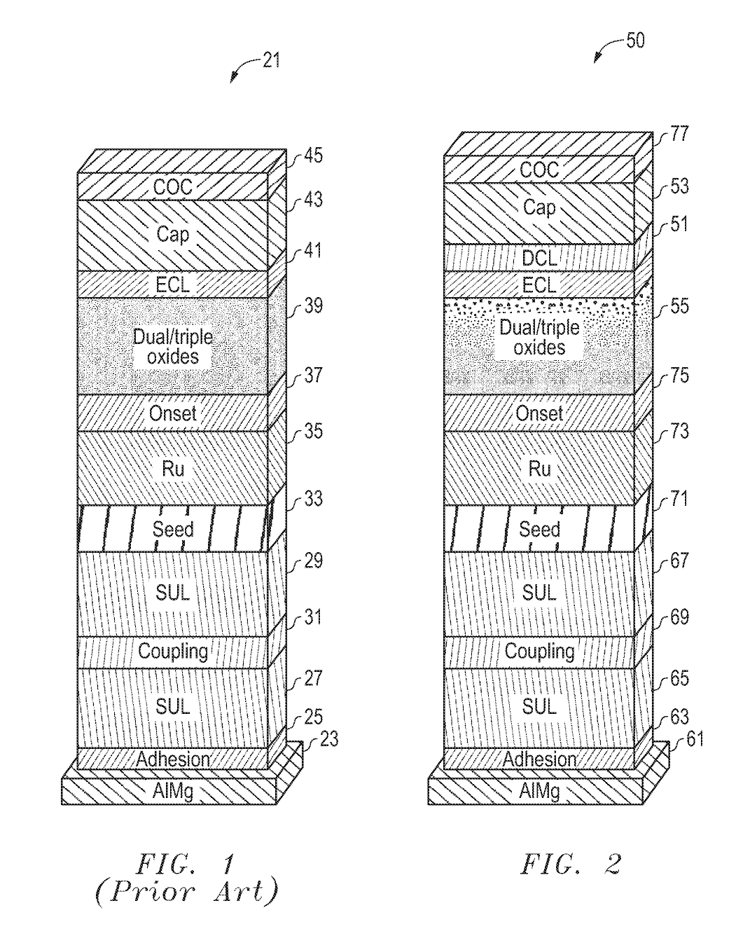

Embodiments of a system, method and apparatus for perpendicular magnetic recording (PMR) media having a decoupling-controlled layer and graded anisotropy are disclosed. As shown in FIG. 2, embodiments of a PMR media 50 use a decoupling-controlled layer (DCL) 51 to reduce lateral exchange coupling in a cap layer 53 of the structure. In some versions, the DCL 51 comprises a CoCrPtB-oxide material. Other embodiments may use a CoPtCrBRu-oxide, a CoPtCrTaBRu-oxide or a CoCrPt-oxide with Ti, Ta, Ru, Ni, Fe, etc. The oxide portion of the material may comprise TiO₂, SiO₂, Ta₂O₅, B₂O₃, CoO, ZrO₂, Al₂O₃, Cr₂O₃.

The PMR media 50 may further comprise a substrate 61, and sequential layers thereon comprising an adhesion layer 63, a pair of soft underlayers (SUL) 65, 67 joined by a coupling layer 69 therebetween. Sequentially layered on the SUL 67 are a seed layer 71, an underlayer 73 such as a Ru, an onset layer 75, and one or more oxide layers 55, such as dual or triple oxides. A carbon overcoat (COC) 77 is formed on the cap layer 53.

The substrate 61 may be formed of a glass material, and may have a greater thickness than the other layers formed thereon. The adhesion layer 63 may comprise aluminum, titanium, or compositions thereof, etc., and may function to prevent the layers formed above the substrate 61 from “peeling off” during use. The SUL 65, 67 are separated by the anti-ferromagnetic coupling (AFC) layer 69, typically of Ru or other AFC materials. The SUL 65, 67 may comprise cobalt, iron, tantalum, zirconium, or compositions thereof, etc., which preferably provide a high moment. The seed layer 71 may comprise any suitable material as would be known in the art, such as nickel, tungsten, chromium, titanium, combinations thereof, etc. The onset layer 75 may comprise ruthenium, titanium, and/or oxides thereof, etc. The oxide magnetic layers 55 may include CoCrPtX+oxide or O₂, where X may be B, Ta, Si, Ru, Ti, etc., and the oxide may be TiOₓ, SiOₓ, B₂O₃, W₂O₅, Ta₂O₅, etc.

Although the DCL 51 improves signal to noise ratio (SNR) at a given magnetic core width (MCW), it also degrades overwrite (OW). As illustrated in FIG. 2, the loss of OW may be recovered by providing the oxide layers 55 with a graded anisotropy structure. Compared to conventional media, the additional combination of the DCL 51 and the composition with graded anisotropy in the oxide layers 55 significantly and simultaneously improves the OW and SNR/bit or soft error rate (SER) of the PMR media 50 at a given MCW.

For a particle in a potential well, the maximum force required to move it from one minimum to another minimum depends on the gradient. The gradient can be decreased by scaling the energy landscape in a horizontal direction. With magnetic properties, the scaling of the energy landscape can be realized by the introduction of magnetic layers with different magnetic anisotropy constants. Upon increasing the total layer thickness, the total magnetic moment increases, and the maximum slope of the energy landscape decreases. Therefore, the magnetic field required to switch the particle can be decreased without changing the energy barrier. D. Suess, et al., Journal of Magnetism and Magnetic Materials (2008).

Anisotropy may be graded by grading the structure. For example, for CoCrPtRu— SiO2-Ta₂O₅ oxide alloys, Pt content is proportional to magnetic anisotropy K, but Cr and Ru content are inversely proportional to anisotropy K. Anisotropy does not have a strong function to oxide content. It may be advantageous to have a higher K in the bottom oxide, medium K in the middle oxide, and lower K in the top oxide. For example, for CoPtCrRu-oxide alloys, the composition gradient may comprise: Pt (bottom)>Pt (middle)>Pt (top), Cr (bottom)<Cr (middle)<Cr (top), and Ru (bottom)<Ru (middle)<Ru (top). This may be generalized for all oxide-containing alloys. For example, bottom oxide alloys may comprise, Pt=17-22 at %, Cr=8-14 at %, Ru=0-4 at %. The oxide portion of the material may comprise TiO₂, SiO₂, Ta₂O₅, B₂O₃, CoO, ZrO₂, Al₂O₃, or Cr₂O₃, for example. The total oxide content may vary from 0.5% to 15% with selected single or multiple oxides.

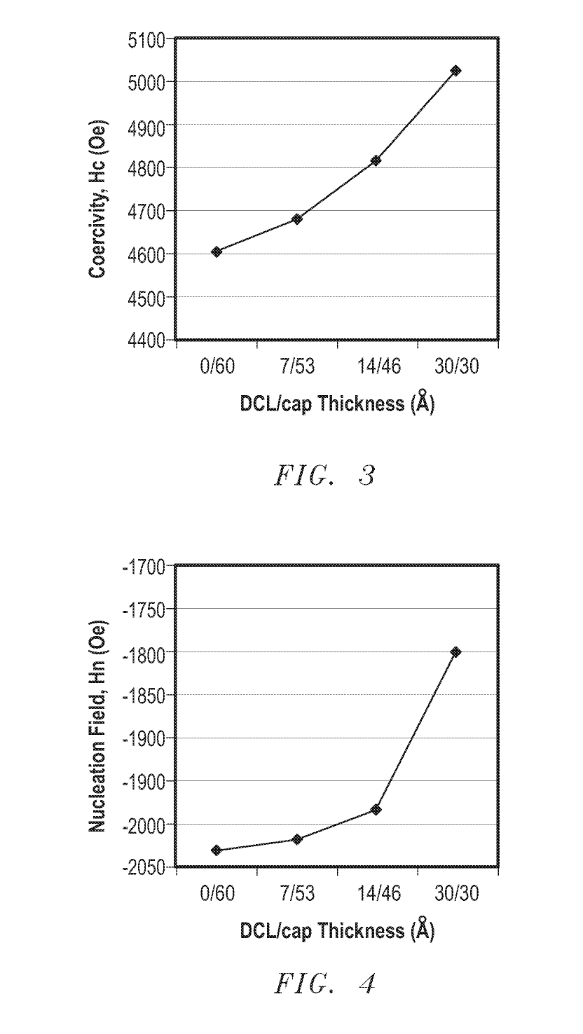

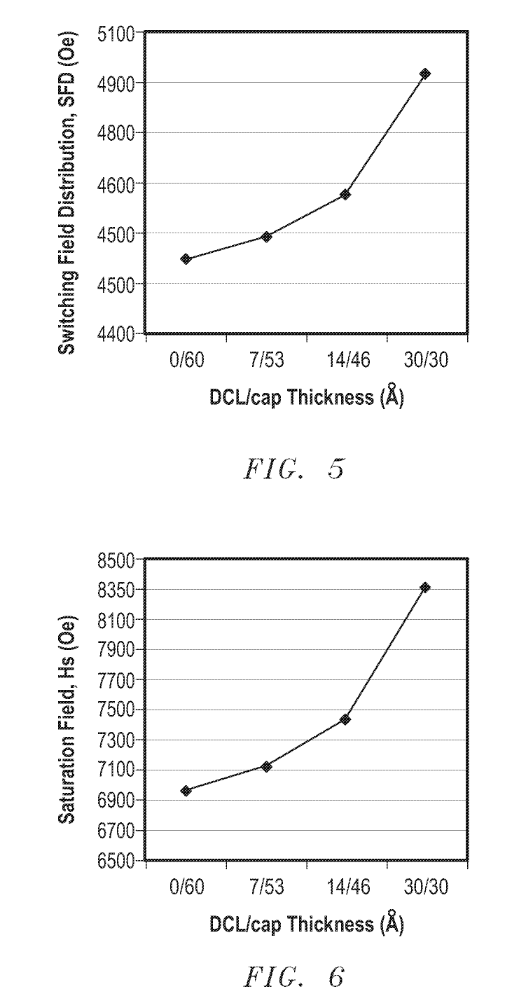

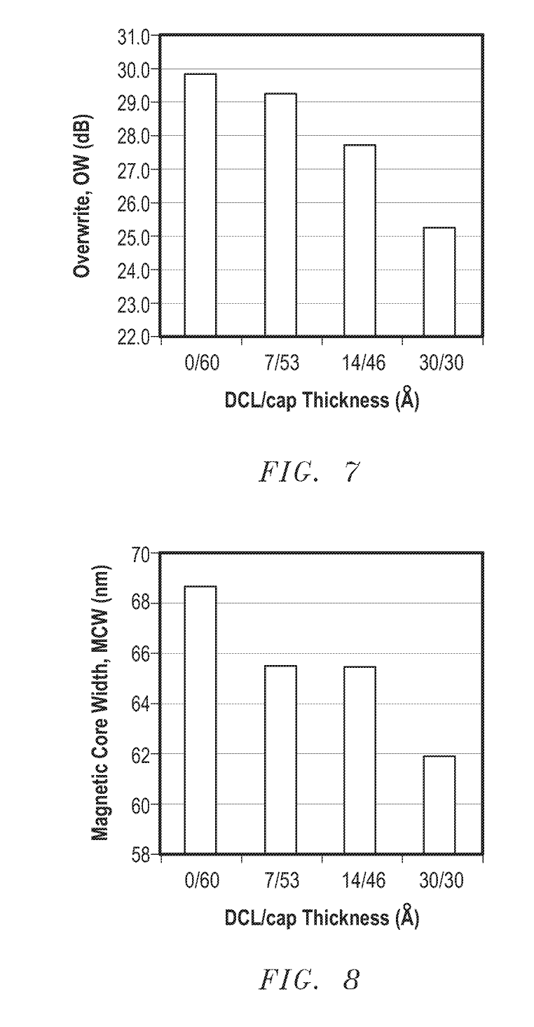

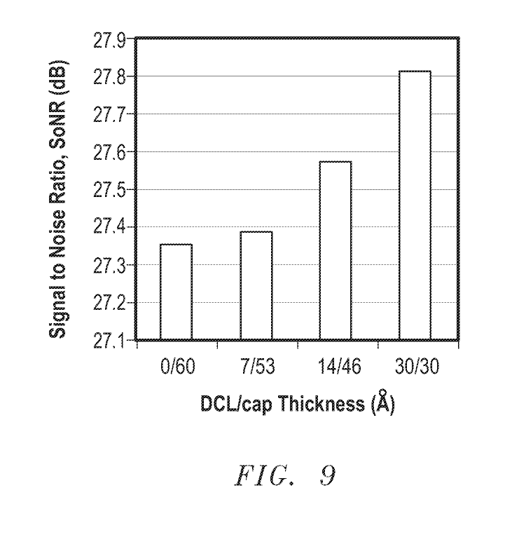

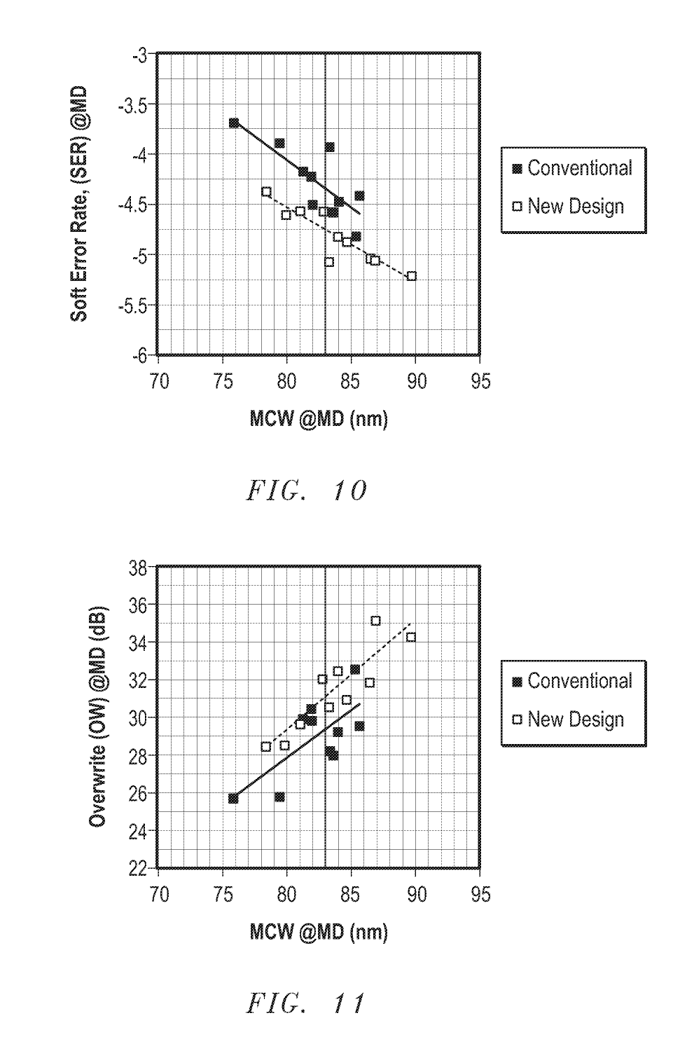

With these improvements, FIGS. 3-9 compare the performance of conventional media with various embodiments of structurally-enhanced media. For example, the 0/60 data points in each of these drawing represent the performance of conventional media having no DCL (i.e., 0 Å thickness) and a cap thickness of 60 Å. FIGS. 3-9 also depict the performance of three embodiments of media having the following combinations of thicknesses: (a) a 7 Å DCL with a 53 Å cap; (b) a 14 Å DCL with a 46 Å cap; and a 30 Å DCL with a 30 Å cap.

FIGS. 3-9 compare the performance of conventional media to the embodiments of media in terms of the following parameters: coercivity (Hc), nucleation field (Hn), switching field distribution (SFD), saturation field (Hs), overwrite (OW), magnetic core width (MCW), and signal-to-noise ratio (SNR), respectively. As the DCL thickness increases, Hc, SFD and Hs become higher, and Hn becomes less negative. This indicates that lateral exchange coupling in the cap layer is suppressed.

In conventional designs, alloys for cap layers typically contain low Cr and high B so that the films using these alloys have strong inter-granular coupling. If the oxide layer was not graded, strong coupling in the cap layer would be the only way to prompt overwritability. However, strong coupling in the cap layer results in high media noise, which limits improvements in SNR. The DCL disclosed herein is used to reduce the inter-granular coupling in the cap layer. Again, magnetic property changes due to reduction of inter-granular coupling can be seen from FIGS. 3-9. As inter-granular coupling reduces, Hc increases, Hn become less negative, SFD and Hs increases also. These illustrations support the fact that the DCL suppresses the inter-granular in the cap layer.

Table 1 summarizes data from a Guzik spin stand test comparing a conventional media and an embodiment of media. The data again shows improved OW, SER and SNR over conventional media.

TABLE 1
Performance comparison

| | OW | | | |
|---|---|---|---|---|
| Sample | (dB) | SER | SoNR | SNR |
| Conventional | 29.0 | −4.3 | 28.2 | 18.3 |
| New | 31.5 | −4.8 | 28.7 | 18.7 |

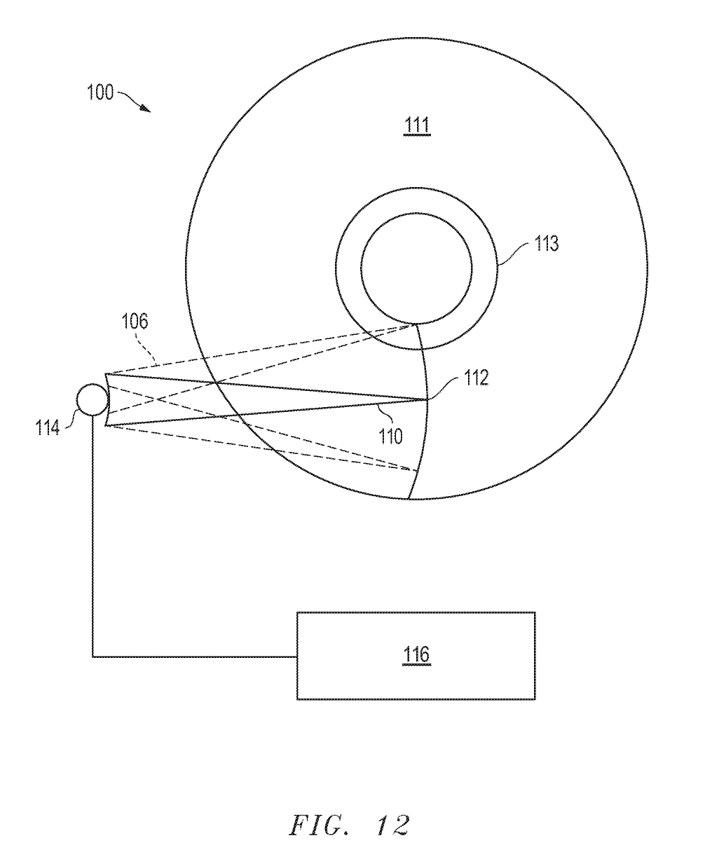

FIGS. 10 and 11 are plots comparing SER and OW, respectively, as functions of MCW of conventional structures and embodiments of structures. For a given MCW, embodiments of media have approximately 0.4 more SER, and 1.5 dB higher OW than conventional media.

Since the DCL suppresses the inter-granular in the cap layer, the media noise (N) is reduced. This fact can be seen in noise normalized by an isolated signal (SoNR), as well as SNR. Isolating SoNR shows the net effect of media noise reduction excluding signal interference from adjacent signals. SNR includes both noise reduction due to the DCL and signal reduction due to interference from adjacent signals. In some embodiments, interference from adjacent signals does not change, so the SNR improvement is mainly due to noise reduction. For this reason, as it can be seen, SoNR and SNR show approximately the same amount of improvement, 0.4-0.5 dB. This reflects an approximately 0.5 order of improvement in SER.

As explained herein, the DCL suppresses the inter-granular in cap layer, resulting in high Hc, SFD and Hs, which make it difficult to overwrite old signals. Poor overwritability leads to narrow magnetic core width. It is desirable to retain narrow magnetic core width for high track density while still improving overwrite. Using graded media as described herein improves OW at a given MCW, as shown in FIG. 11.

In some embodiments, the PMR media comprises a substrate having a plurality of sequential layers comprising an adhesion layer, a first soft underlayer (SUL), a coupling layer, a second SUL, a seed layer, a Ru layer, and an onset layer; at least one oxide layer on the onset layer and having a composition with graded anisotropy to improve overwrite (OW) of the PMR media; an exchange coupling layer (ECL) on the at least one oxide layer; a cap layer; a decoupling-controlled layer (DCL) between the ECL and the cap layer to reduce lateral exchange coupling in the cap layer on the ECL; and a carbon overcoat (COC) on the cap layer.

The composition of the at least one oxide layer may comprise a first portion adjacent the onset layer having a soft anisotropy, a second portion having moderate anisotropy in excess of the soft anisotropy, and a third portion having a higher anisotropy than the second portion.

The DCL may comprise a CoCrPtB-oxide, or a CoCrPt-oxide with Ti, Ta, Ru, Ni, or Fe, and an oxide of the DCL comprises TiO₂, SiO₂, Ta₂O₅, B₂O₃, CoO, ZrO₂, Al₂O₃, or Cr₂O₃. The DCL and the cap layer may have a combined total thickness of about 20 to 80 Å (about 60 Å, in some embodiments), and a thickness ratio of ECL to DCL is about 0.05 to 0.8.

FIG. 12 depicts a schematic diagram of an embodiment of a hard disk drive assembly 100. The hard disk drive assembly 100 generally comprises a housing or enclosure with one or more disks as described herein. The disk comprises magnetic recording media 111 (described herein), rotated at high speeds by a spindle motor (not shown) during operation. The concentric data tracks 113 are formed on either or both disk surfaces magnetically to receive and store information.

Embodiments of a read or read/write head 110 may be moved across the disk surface by an actuator assembly 106, allowing the head 110 to read or write magnetic data to a particular track 113. The actuator assembly 106 may pivot on a pivot 114. The actuator assembly 106 may form part of a closed loop feedback system, known as servo control, which dynamically positions the read/write head 110 to compensate for thermal expansion of the magnetic recording media 111 as well as vibrations and other disturbances. Also involved in the servo control system is a complex computational algorithm executed by a microprocessor, digital signal processor, or analog signal processor 116 that receives data address information from a computer, converts it to a location on the media 111, and moves the read/write head 110 accordingly.

In some embodiments of hard disk drive systems, read/write heads 110 periodically reference servo patterns recorded on the disk to ensure accurate head 110 positioning. Servo patterns may be used to ensure a read/write head 110 follows a particular track accurately, and to control and monitor transition of the head 110 from one track 113 to another. Upon referencing a servo pattern, the read/write head 110 obtains head position information that enables the control circuitry 116 to subsequently realign the head 110 to correct any detected error.

Servo patterns may be contained in engineered servo sections 112 embedded within a plurality of data tracks 113 to allow frequent sampling of the servo patterns for improved disk drive performance, in some embodiments. In a typical magnetic recording media 111, embedded servo sections 112 extend substantially radially from the center of the magnetic recording media 111, like spokes from the center of a wheel. Unlike spokes however, servo sections 112 form a subtle, arc-shaped path calibrated to substantially match the range of motion of the read/write head 110.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A perpendicular magnetic recording (PMR) media, comprising:
a substrate having a plurality of sequential layers comprising an adhesion layer, a first soft underlayer (SUL), a coupling layer, a second SUL, a seed layer, a Ru layer, and an onset layer;
at least one oxide layer on the onset layer and having a composition with graded anisotropy to improve overwrite (OW) of the PMR media;
an exchange coupling layer (ECL) on the at least one oxide layer;
a cap layer;
a decoupling-controlled layer (DCL) between the ECL and the cap layer to reduce lateral exchange coupling in the cap layer on the ECL; and
a carbon overcoat (COC) on the cap layer.

2. A PMR media according to claim 1, wherein the composition of the at least one oxide layer comprises a first portion adjacent the onset layer having a soft anisotropy, a second portion having moderate anisotropy in excess of the soft anisotropy, and a third portion having a higher anisotropy than the second portion.

3. A PMR media according to claim 1, wherein the DCL comprises a CoCrPtB-oxide.

4. A PMR media according to claim 1, wherein the DCL comprises a CoCrPt-oxide with Ti, Ta, Ru, Ni, or Fe, and an oxide of the DCL comprises TiO₂, SiO₂, Ta₂O₅, B₂O₃, CoO, ZrO₂, Al₂O₃, or Cr₂O₃.

5. A PMR media according to claim 1, wherein the DCL and the cap layer have a combined total thickness of about 20 to 80 Å, and a thickness ratio of ECL to DCL is about 0.05 to 0.8.

6. A hard disk drive, comprising:
an enclosure;
a disk rotatably mounted to the enclosure, the disk having perpendicular magnetic recording (PMR) media comprising a substrate having a plurality of sequential layers comprising an adhesion layer, a first soft underlayer (SUL), a coupling layer, a second SUL, a seed layer, a Ru layer, and an onset layer, at least one oxide layer on the onset layer and having a composition with graded anisotropy to improve overwrite (OW) of the PMR media, an exchange coupling layer (ECL) on the at least one oxide layer, a cap layer, a decoupling-controlled layer (DCL) between the ECL and the cap layer to reduce lateral exchange coupling in the cap layer on the ECL, and a carbon overcoat (COC) on the cap layer;
an actuator movably mounted to the enclosure and having a head for reading data from the PMR media.

7. A hard disk drive according to claim 6, wherein the DCL comprises CoCrPtB-oxide.

8. A hard disk drive according to claim 6, wherein the composition of the at least one oxide layer comprises a first portion adjacent the onset layer having a soft anisotropy, a second portion having moderate anisotropy in excess of the soft anisotropy, and a third portion having a higher anisotropy than the second portion.

9. A hard disk drive according to claim 6, wherein the DCL comprises a CoCrPt-oxide with Ti, Ta, Ru, Ni, or Fe, and an oxide of the DCL comprises TiO₂, SiO₂, Ta₂O₅, B₂O₃, CoO, ZrO₂, Al₂O₃, or Cr₂O₃.

10. A hard disk drive according to claim 6, wherein the DCL and the cap layer have a combined total thickness of about 20 to 80 Å, and a thickness ratio of ECL to DCL is about 0.05 to 0.8.
